(19) United States
(12) Patent Application Publication
(10) Pub. No.: US 2011/0196995 A1
(43) Pub. Date: Aug. 11, 2011

(54) HAND-HOLD MEASURING-EQUIPMENT USB RECORDING DEVICE

(76) Inventor: Dong-Chang Lin, Taipei City (TW)

(21) Appl. No.: 12/701,522

(22) Filed: Feb. 6, 2010

(51) Int. Cl. G06F 13/00

(52) U.S. Cl. 710/33; 710/301

(57) ABSTRACT

The present invention is to provide a hand-hold measuring-equipment recoding device that is mainly improvements aimed at the small sized hand-hold measuring equipment. The measuring machine body having a display, several buttons, and a sensor set in it, and is characterized in that a memory card slot is set in the machine body to provide for the insertion of the SD card. And, there are set with a microprocessor, a sensor circuit, and a memory card driver circuit in the machine body. Through these, the measured data records and measuring time are saved directly in the SD memory cards, then the SD memory cards is utilized to be inserted in the computer to read data and perform a further data analysis. Thus, it can solve the former problems of inconvenience caused by the measuring equipment must connect with the computer through a transferring cable and must proceed the measuring at the measuring site simultaneously while measuring.

### BACKGROUND OF THE INVENTION

According to what we have known, a small-sized hand-hold measuring equipment itself has a signal transferring connector, and it requires to be cooperated with a computer while proceeds the environment measurement. It is then connected with the computer such that the measured data from the measuring equipment can be read and analyzed. And, the computer requires to be installed the special software and execute them such that the collected data can be transferred to the computer. Therefore, it causes enormous inconvenience and really needs to be improved.

### SUMMARY OF THE INVENTION

The present invention is to provide a hand-hold measuring-equipment USB recording device that is mainly improvements aimed at the small sized hand-hold measuring equipment. It can directly save the measured data records and measuring time in the potable USB, then the said USB is utilized to be inserted in the computer to read data and perform a further data analysis. The structures of the present invention will be described hereafter by referring to the following drawings.

### BRIEF DESCRIPTION OF THE DRAWINGS

FIG. 1 is an outside appearance diagram of the measuring equipment according to the present invention.

FIG. 2 is a top plan diagram of the measuring equipment according to the present invention.

FIG. 3 is a bottom plan diagram of the measuring equipment according to the present invention.

FIG. 4 is a block diagram of the setup form in the device of the present invention.

### DETAILED DESCRIPTION OF THE PREFERRED EMBODIMENT

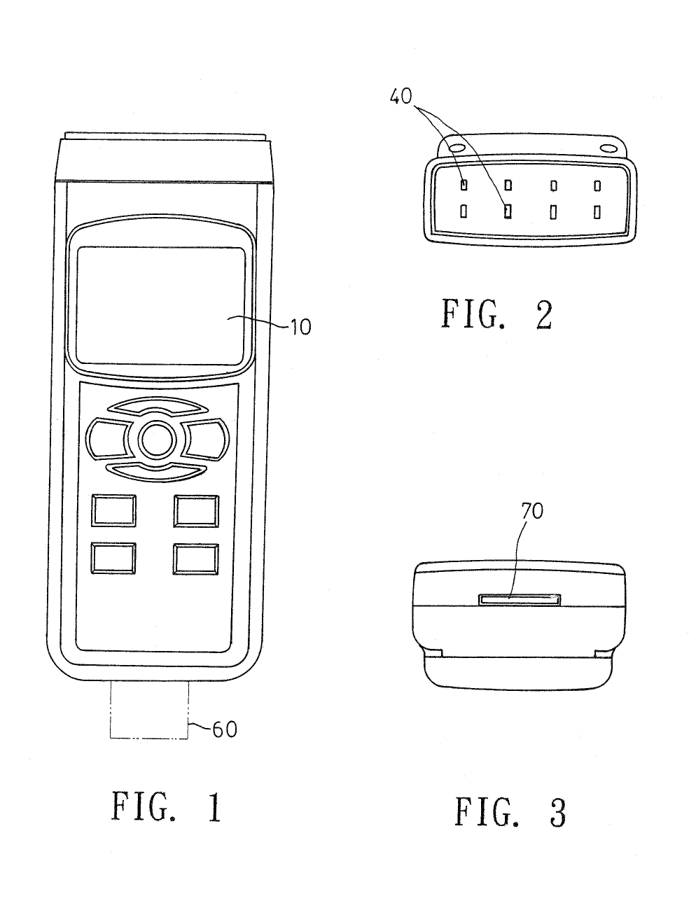

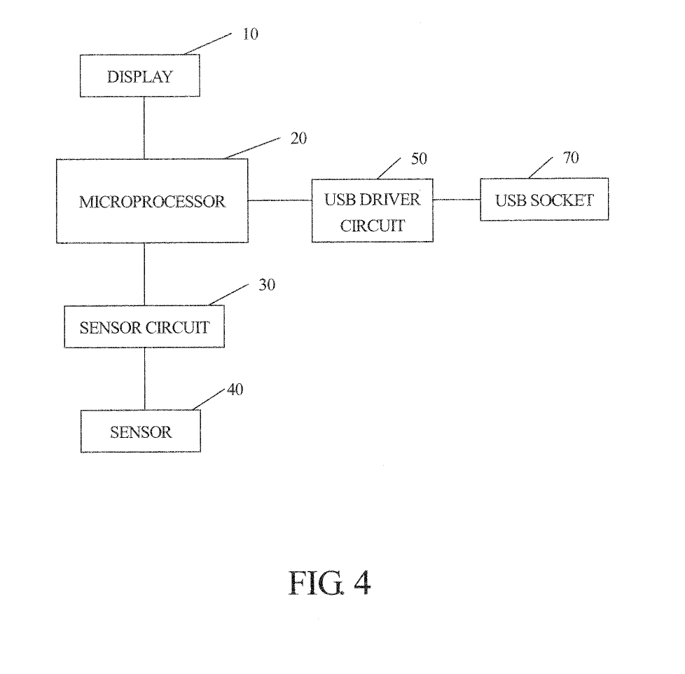

Please refer to those shown in FIGS. 1 to 4. The hand-hold measuring-equipment mainly is set in the machine body with a display 10, several sensors 40, and a USB socket 70 provided for the insertion of the potable USB 60. And, there are set with a microprocessor 20 (CPU-central processing unit), a sensor circuit 30, and a USB driver circuit 50. While using, the USB socket 70 can be provided for an insertion of the USB 60 from the exterior, the sensor 40 on the measuring equipment is utilized to carry out the data measurement and record the measured values and time, and is directly saved in the USB 60. And, the data files of the USB can be formatted to be a format that is directly readable by the Microsoft Excel software. After completing the recording, it only needs to pull out the USB 60, insert it in the reader of computer then the computer reads the data directly by Excel to carry out a further data analysis. Through these, we can solve the former problems of inconvenience caused by the measuring equipment must connect with the computer through a transferring cable and must proceed the measuring at the measuring site simultaneously while measuring.

The hand-hold measuring-equipment USB recording device in the present invention can be suitable in measuring the values of humidity, voltage, current, temperature, power, sound level, pressure, barometer, pH, conductivity, magnetic, electro magnetic field, carbon monoxide, carbon dioxide, vibration, RPM, Moisture, Chlorine, turbidity, Oxygen, and air velocity.

1-3. (canceled)

4. In a hand-hold measuring equipment recording device comprising a body portion provided with a display, a microprocessor, a sensor circuit, and a USB driver circuit, the improvement wherein said body portion has a USB slot and a USB memory stick is inserted into said USB socket, data file format of said USB memory stick being a format that is directly readable by Excel, and a sensor for carrying out data measurement and recording measured valves and time which are saved in said USB memory stick.
